(19) United States
(12) Patent Application Publication
(10) Pub. No.: US 2025/0173549 A1
(43) Pub. Date: May 29, 2025

(54) MULTI-DECODER CLASSIFICATION ARCHITECTURE FOR COARSE-GRAINED CATEGORIZED DATA

(71) Applicant: Oracle International Corporation, Redwood Shores, CA (US)

(72) Inventors: Tomas Feith, Zurich (CH); Arno Schneuwly, Effretikon (CH); Saeid Allahdadian, Vancouver (CA); Matteo Casserini, Zurich (CH); Felix Schmidt, Baden-Dattwil (CH)

(21) Appl. No.: 18/519,307

(22) Filed: Nov. 27, 2023

(51) Int. Cl. G06N 3/0455; G06N 3/084

(52) U.S. Cl. CPC G06N 3/0455; G06N 3/084

(57) ABSTRACT

A pretraining computer generates a neural encoder and multiple partition decoders (PDs) for respective partitions of training inputs (TIs) in a training corpus. A training batch is generated that contains a mix of TIs from multiple partitions. For each TI in the batch, the neural encoder infers an encoding and, based on the partition of the TI, exactly one PD is used to decode the encoding, for which an individual loss is measured. The individual loss is combined into a batch loss that is based on the entire batch, and combined into a partition loss that is based on TIs only in the partition of the exactly one PD. After measuring losses for the batch, the batch loss is backpropagated into the neural encoder without backpropagating the batch loss into any PD. Into each PD is backpropagated a respective partition loss that is based on TIs only in the decoder's partition.

### FIELD OF THE INVENTION

The present invention relates to encoder pretraining. Herein is increased pretraining accuracy based on training corpus partitioning for accelerated training of partition-specific decoders.

### BACKGROUND

Classification is a fundamental technique in machine learning. Given an input and a set of labels, the goal of this task is to assign one or more labels to the input. If there are only two labels the task is binary classification. If there are multiple labels and the goal is to predict which one label is best suited to the input, the task is called multi-class classification. On the other hand, if there are multiple labels and the goal is to predict what subset of labels are related to the input, the task is called multi-label classification.

Early work used encoder-only models to produce classification predictions. For example, convolutional neural networks (CNNs) were used for image classification, and gated recurrent units (GRUs) for audio classification.

However, more recent work has shown encoder-decoder models can achieve better results. Typically, these models harness a large encoder model to compute a contextual vector representation of the input. Then, a classification head is attached to the encoder to decode the vector representation into the label space, which is successful in a basic case such as logic clone detection and other binary classification problems.

Multi-label classification is the most difficult for several reasons. Multi-label classification for ten labels may be more or less feasible in the state of the art. However, with the growing complexity of datasets and tasks, the number of labels has grown tremendously to more than a hundred, or more than a thousand. For example ImageNet, a large-scale hierarchical image database, contains a thousand labels, and a real world product catalog may exceed 300,000 labels. Such a large number of labels poses an increased learning effort to a classifier model, because the model has to consider all labels for every input. An immense label space may infeasibly prolong model training and, in any case, substantially decrease inference accuracy.

Additionally, the large number of labels can also lead to excessive rounding error and other numerical instabilities such as underflow or overflow when inferring a probability for a label by, for example, summation or averaging. Classification problems with a very large number of labels are referred to as extreme classification problems. Extreme classification is an active research field that provides an extensive overview of current approaches. Current methods, however, may be based on additional machine learning to preprocess a training corpus by dimensionality reduction in various ways, with training a preprocessor being an additional process with substantial latency that is not concurrent to classifier training that requires an already trained preprocessor.

### BRIEF DESCRIPTION OF THE DRAWINGS

In the drawings:

FIG. 1 is a block diagram that depicts an example computer that increases the pretraining accuracy of a neural encoder based on training corpus partitioning for accelerated training of multiple partition decoders;

FIG. 2 is a flow diagram that depicts an example computer process to increase the pretraining accuracy of a neural encoder based on training corpus partitioning for accelerated training of multiple partition decoders;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is encoder pretraining having increased accuracy due to training corpus partitioning that also accelerates training of partition-specific decoders. This entails a novel multi-decoder architecture based on a coarse-grained data categorization into semantic partitions of a training corpus. This technique is general and can be applied to any classification problem where the training data can be split into coarse-grained partitions, such that each partition contains only a subset of labels that occur in the training data. Pretraining herein entails the following two stages in sequence, such as stages in an automated machine learning pipeline.

The first stage minimally preprocesses the training corpus, and this preprocessing is based on rules instead of learned inferences. Partitioning rules do not require training latency for themselves. An embodiment may partition training items without inspecting the contents of the training items. For example, preexisting natural physical partitions may be sufficient, in which case this first stage may be avoided for additional acceleration. For example, each partition may already be separately siloed as discussed later herein.

The purpose of the first stage is to separate training items so that the items can be routed, after encoding by an encoder in training, to a decoder that is dedicated to the semantics of a respective distinct partition. That is, each training partition has its own special decoder that is unlike a state of the art decoder that tolerates unpartitioned data. Herein, the encoder may be unaware that the training corpus is partitioned and after pretraining, for example, the encoder can be deployed into finetuning or into production without partitions. Pretraining and subsequent finetuning are discussed later herein.

The first stage may or may not require domain knowledge to split the data into clear, semantically distinct partitions. Considering a training dataset D, the data is divided into C partitions. The granularity of the partitions may be selected according to the data and the downstream classification task. In an embodiment, a few of many labels may occur in more than one partition, which is not ideal but nonetheless is well tolerated by this approach so long as most labels occur only in one partition.

The second stage generates C small decoders, which is one dedicated to each of the C partitions, and no decoder is responsible for more than a minority of the labels in the training corpus. Considering back-propagation rules, each decoder is trained only using its own partition of the training corpus, even though the encoder trains with the entire corpus. This approach avoids causing a decoder to consider all labels when making a classification or other prediction, which would waste runtime and increase the learning effort of a decoder. Using this architecture, pretraining latency is decreased, which is especially beneficial because pretraining naturally is much slower than subsequent finetuning. This training architecture that combines an encoder and multiple decoders can subsequently be deployed into production with the encoder and only one or a few of the decoders or none of the decoders as discussed later herein.

This approach includes at least the following innovations. Coarse-grained dataset categorization decreases the number of labels each decoder needs to predict, and this partitioning is not performed by an additional model, which also would need its own training. Decoder splitting avoids one single decoder to predict the probabilities of all labels, and instead there are as many decoders as partitions, and each decoder is tasked with predicting only labels in its own partition.

This approach provides at least the following advantages. The multi-decoder architecture increases training stability by using smaller label spaces. Training instability discussed in the above Background is avoided. This multi-decoder architecture accelerates a classifier/decoder without decreasing accuracy because the encoder learns to capture as much semantic information as possible. In an embodiment, the classifier is a linear neural layer that maps the encoder's encoded representation of the input to the label space. In this approach, each decoder is tasked with predicting a smaller number of labels, which needs fewer linear neural layers. Since the encoded input is only processed by one decoder, the decoder is accelerated, which accelerates the encoder in training. There is no decrease in expressiveness of the encoder because, unlike the decoders, the encoder pretrains with the entire corpus.

When compared to learned label partitioning methods, the approach herein decreases latency, increases model explainability, and has fewer hyperparameters, which accelerates hyperparameter tuning. For example, preprocessing by learned clustering is slower than the approach herein, and cluster count is a hyperparameter that is slow to tune. Because as discussed later herein, each partition may have a clear and interpretable meaning, this approach increases model explainability. For example, an explanation generated based on a tuned amount of statistically discovered multidimensional clusters may be more or less impractical for a human to interpret.

In an embodiment, a pretraining computer generates many untrained machine learning models that include a neural encoder and multiple partition decoders for multiple respective partitions of training inputs in a training corpus. A training batch is generated that contains a mix of training inputs from multiple partitions. For each training input in the batch, the neural encoder infers an encoding and, based on the partition of the training input, exactly one respective partition decoder is used to decode the encoding, for which an individual loss is measured. The individual loss is combined into a batch loss that is based on the entire batch, and also combined into a partition loss that is based on training inputs only in the partition of the exactly one partition decoder. After measuring those various losses for the whole batch, the batch loss is backpropagated into the neural encoder without backpropagating the batch loss into any partition decoder. Into each partition decoder is backpropagated a respective partition loss that is based on training inputs of the batch only in the decoder's partition.

### 1.0 Example Computer

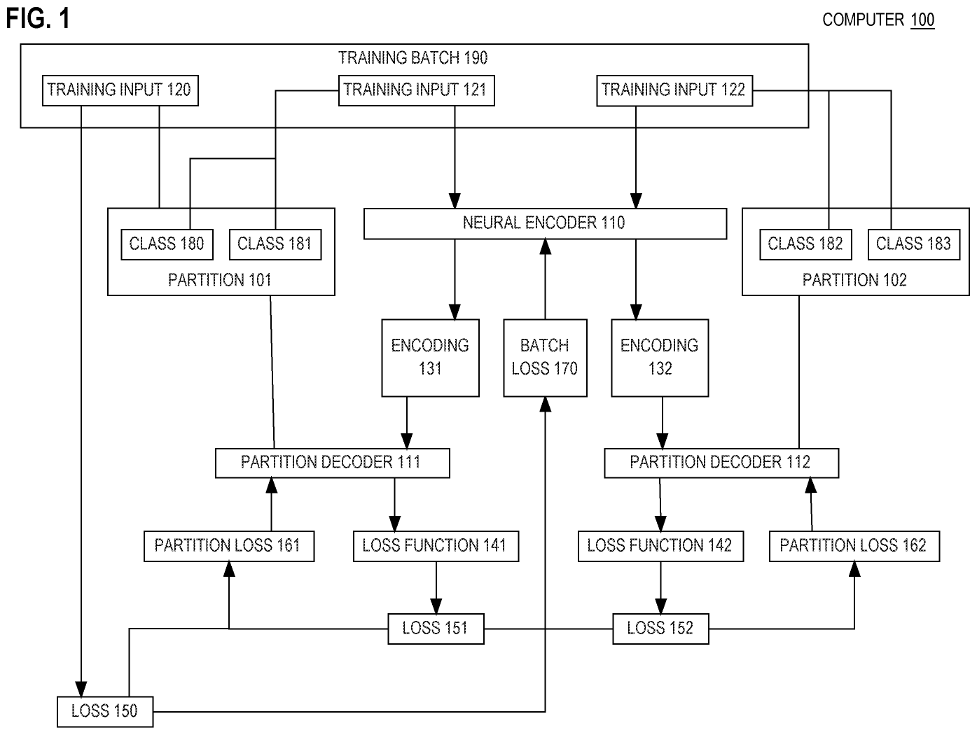

FIG. 1 is a block diagram that depicts an example computer 100 that increases the pretraining accuracy of neural encoder 110 based on training corpus partitioning for accelerated training of partition decoders 111-112. Computer 100 may be one or more of a rack server such as a blade, a personal computer, a mainframe, or a virtual computer.

A corpus of training data may be logically partitioned according to rules into many mutually exclusive semantic partitions 101-102. For example, neural encoder 110 may be a multi-language model, and each of partitions 101-102 may be a distinct language that occurs in the training corpus. Partitions 101-102 are mutually exclusive. For example, a corpus of training items that are documents may consists of some documents that contain only Latin and other documents that contain only English, and neural encoder 110 may generate a dense and semantic encoding of any document, regardless of which natural language. In an embodiment discussed later herein, the languages instead are programing languages. In an embodiment, neural encoder 110 is not a language model; partitions 101-102 are not languages; and training items in the training corpus are not documents. For example, the training corpus may be tabular, and a row in a spreadsheet or a row in a database table may be a training item. However in any case, neural encoder 110 infers (i.e. generates) a dense semantic encoding that has a fixed size.

Herein, a training item is also referred to as a training input. A training input may be encoded as a fixed size feature vector such as an array of numbers, or as a variable length sequence of lexical tokens. Depending on the embodiment, a training input may be dense or sparse, which might entail spatially expensive value encodings such as one hot or lexical sub-words.

### 1.1 Semantic Partitions of Training Inputs in Corpus

Each training input belongs to exactly one of semantic partitions 101-102. In an embodiment, the training corpus is physically partitioned into partitions 101-102. For example, each of partitions 101-102 may have a respective distinct database table or file that stores training inputs. In that case, the training corpus does not need preprocessing to analytically assign training inputs to partitions. For example, each of partitions 101-102 may be stored in a distinct respective data silo. In an embodiment, the sole partition of a given training input is discoverable without inspecting the content of the training input.

Even though partitions 101-102 are separated, training batch 190 may contain a mix of training inputs from many or all partitions 101-102. Training or pretraining of machine learning models 110-112 is accelerated by batching. In this example, pretraining of neural encoder 110 entails training of partition decoders 111-112, and partition decoders 111-112 may be discarded after pretraining neural encoder 110. An unbatched embodiment may logically operate in a same way as a batched embodiment whose batch size is one (i.e. a single training input).

### 1.2 Pretraining Before Finetuning

During pretraining, training, or inferencing in a production environment, neural encoder 110 accepts one input, which causes neural encoder 110 to infer (i.e. generate) one inference that is a fixed size semantic encoding that represents the input. In production, the encoding is likely to be highly accurate but, in training or pretraining or finetuning, the encoding may be more or less inaccurate. Herein, training of neural encoder 110 may or may not occur as a sequence of two phases that are slow pretraining followed (e.g. by a different party in a different environment on a different computer) fast finetuning. Pretraining entails an immense and diverse training corpus to increase accuracy and avoid overfitting. The physical costs of slow and electricity-intensive pretraining is amortized across as many applications that will eventually embed neural encoder 110. Finetuning entails application specific data that might be proprietary, and finetuning entails very few training inputs for rapid convergence. Thus, pretraining has a large resource budget, and finetuning does not, which may increase adoption of neural encoder 110.

### 1.3 Encoding by Neural Encoder

At the beginning of pretraining, all of machine learning models 110-112 are untrained. In the shown pretraining example, neural encoder 110 infers encoding 131 from training input 121 and separately infers encoding 132 from training input 122. It does not matter to neural encoder 110 that training input 121 is in partition 101 and training input 122 instead is in partition 102. Accuracy of encodings 131-132 is not directly measured. For training purposes, multiple partition decoders 111-112 are used to indirectly measure the accuracy of encodings 131-132.

Each of partitions 101-102 has its own respective one of partition decoders 111-112. Herein, a partition decoder has a training task that may only entail decoding (e.g. to regenerate a training input), or may entail semantic behavior for a particular representation data structure such as a logical tree, a logical graph, or a lexical token sequence. Example training tasks such as classification are discussed later herein. Both of partition decoders 111-112 may have similar training tasks. For example as discussed later herein, if partition decoder 111 reacts to tree traversal semantics, then so too does partition decoder 112.

In pretraining, inaccuracy of each of encodings 131-132 is respectively quantitatively measured as loss 151-152, and these loss measurements are supervised according to training labels (not shown) for partition-specific classes 180-183. In other words, training of partition-specific decoders 111-112 is supervised. In this example, partition-specific decoders 111-112 are classifiers, and classes 180-183 are classification classes that are disjoint (i.e. mutually exclusive) between partitions 101-102 but are shared within a given partition. For example in partition 101, both training inputs 120-121 are labeled for each of classes 180-181, but no training input in partition 102 can have a label for any of classes 180-181. Thus, partitions ideally do not share classes, although some overlap (i.e. shared classes) is well tolerated. Classes 180-183 are partitioned amongst partitions 101-102, and this partitioning is predefined. Different partitions may have different counts of classes.

### 1.4 Multiple Partition-Specific Decoders for Multi-Label Classification

In this example, classification is multi-label. For example, training input 121 has two training labels respectively for classes 180-181. In an embodiment, a label is a Boolean that indicates that a training input is or is not a member of a particular class. In an embodiment, a label is a probability (i.e. from zero to one) that the training input is or is not a member of a particular class. In an embodiment, a label is a frequency (e.g. count or unit-normalized count) of some data or condition that occurs in the training input, and each distinct data or condition is represented by a distinct class. For example, class 180 may be wheels and class 181 may be doors, and training input 121 may be a photograph that has a respective frequency label for each of classes 180-181.

In one example, an inference by partition decoder 111 may entail generating a decoding of encoding 131, and that inferred decoding (not shown) contains a respective numeric probability for each of classes 180-181. For example, a probability of one for class 180 may indicate a very high likelihood that training input 121 is a member of class 180.

In a multi-label embodiment in which partition decoder 111 performs binary detection (i.e. yes or no) of classes 180-181, the inferred probabilities do not individually exceed one but can exceed one when summed together. In a multi-label embodiment in which partition decoder 111 detects frequency, each individual probability may exceed one to indicate frequency. In an embodiment, frequency is normalized so that integer frequencies are downscaled into a unit normal range from zero to one.

In an embodiment, supervised loss measurement entails applying a partition-specific loss function, in which case each of partition decoders 111-112 has its own respective loss function 141 or 142 that may use partition-specific classes to measure respective losses 151-152 for encodings 131-132. For example, loss function 141 for partition 101 is based on classes 180-181 of partition 101 and not based on classes 182-183 of partition 102. Thus, the label space (i.e. count of distinct classes) for elements 111 and 141 is decreased by at least one order of magnitude as compared to the full space of all classes 180-183 for all partitions.

### 1.5 Improved Computer Performance

This decrease in distinct class count increases the speed and accuracy of training partition decoders 111-112, which increases the speed and accuracy of pretraining neural encoder 110. Herein those accelerations are further accelerated by innovative application of losses to machine learning models 110-112 based on training batch 190. State of the art batch training measures, as a single scalar number, a combined loss from all training inputs in a training batch, which is shown as batch loss 170. However, batch loss 170 is insufficient to achieve full acceleration herein.

Instead additional novel acceleration is provided by partition-specific loss aggregations shown as partition losses 161-162. For example aggregate measurements 161-162 and 170 may be calculated by summation or averaging of some or all of individual losses 150-152 for training batch 190 as follows. Batch loss 170 combines all of losses 150-152 for training batch 190. Partition losses 161-162 instead combine only individual losses of a respective one of partitions 101-102.

For example, losses 150-151 from respective training inputs 120-121 in partition 101 are arithmetically combined to generate partition loss 161. Partition loss 161 is used to provide increased accuracy because partition loss 161 is used to train only partition decoder 111 but not 112. In other words, accuracy of training partition decoder 112 is increased by avoidance of adjustment of the internals of partition decoder 112 based on training inputs of partition 101 that are not intended for partition decoder 112. For example, partition decoders 111-112 may be artificial neural networks that learn by neural backpropagation that entails internal adjustment of numeric weights of connections between neurons, which may entail slow measurement of gradients by calculus. In that case, losses 150-151 and 161 that are very meaningful to partition decoder 111 would instead only be noise that would decrease accuracy if unnecessarily used to also train partition decoder 112. Herein, increased training accuracy accelerates training by reaching convergence (e.g. desired accuracy) sooner.

As shown, partition 101 has more training inputs in training batch 190 than partition 102, which may or may not mean that partition 101 also has more training inputs in the training corpus itself than partition 102. For example, training inputs may be selected for inclusion in training batch 190 by random sampling, with or without replacement, and without regard for partitions.

In the state of the art, decoder learning by internal adjustment such as by neural backpropagation may entail batch loss 170. However as shown, partition decoder 111 uses partition loss 161 instead of batch loss 170, even if batch loss 170 reflects partition losses 161-162.

### 2.0 Example Pretraining Process

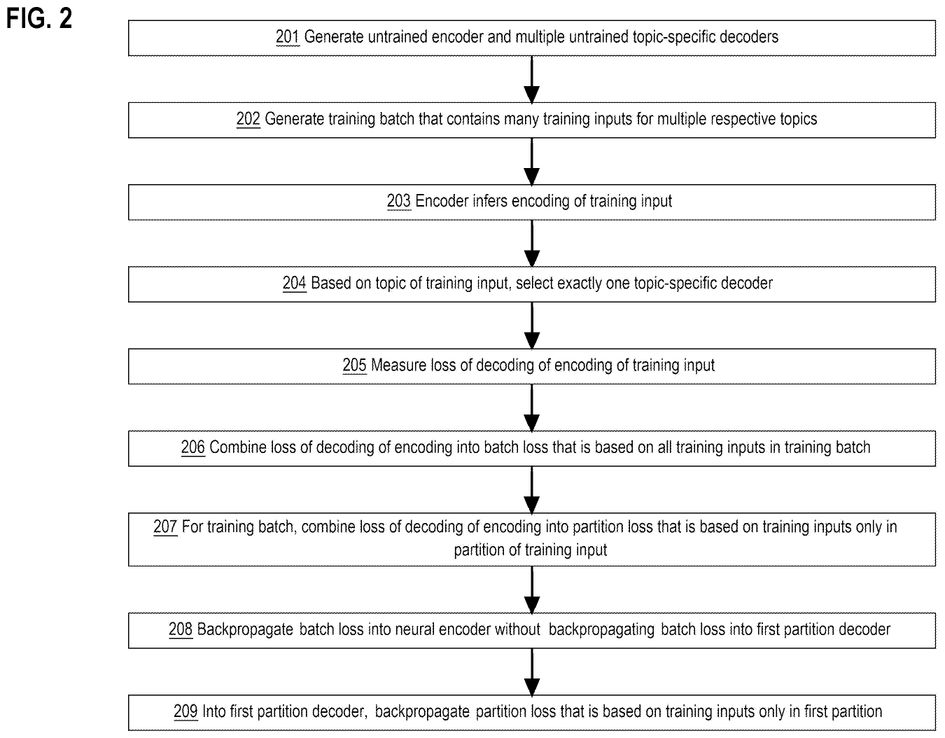

FIG. 2 is a flow diagram that depicts an example process that computer 100 may perform to increase the pretraining accuracy of neural encoder 110 based on training corpus partitioning for accelerated training of partition decoders 111-112.

In the memory of computer 100, preparatory step 201 generates untrained neural encoder 110 and multiple untrained partition decoders 111-112. For example in a neural embodiment, step 201 may allocate and initialize numeric matrices that contain connection weights.

Pretraining by the process of FIG. 2 may entail multiple training batches. Steps 202-209 are repeated for each training batch. Step 202 generates training batch 190 that contains many training inputs 120-122 for multiple respective partitions 101-102, which may entail random sampling of training inputs from the training corpus without regard to partitions 101-102. Although step 202 does not depend on partitions 101-102, step 202 may nonetheless record the partition of each of training inputs 120-122. Herein, partitions are preassigned to training inputs and, as discussed earlier herein, partition reassignment does not entail a learned inference and, in an embodiment, does not entail inspection of content of a training input. Each training batch contains a same predefined fixed count of training inputs.

Steps 203-207 are repeated for each training input in training batch 190. In step 203, neural encoder 110 infers, for example, encoding 131 of training input 121. Encodings 131-132 have a same predefined fixed size that is a count of bytes or a count of numeric array elements. Step 203 does not depend on the partition of a training input. In that way, neural encoder 110 is a universal encoder that can semantically encode training instances from many partitions 101-102.

Based on the preassigned partition of the training input, step 204 selects exactly one of partition decoders 111-112. Step 204 does not depend on the encoding by step 203, and steps 203-204 may be reversed or concurrent for a training input. The exactly one partition decoder accepts the encoded training input. For example, step 204 may select partition decoder 111 and, from encoding 131, partition decoder 111 may infer a decoding (not shown). Only partition decoder 111 accepts encoding 131 as input, and other partition decoder 112 is not provided encoding 131 as input.

Step 205 supervised measures an individual loss (i.e., magnitude of error) of decoding of, for example, encoding 131 of training input 121, which may entail applying partition-specific loss function 141 that may generate loss 151 based on classes 180-181 of partition 101. For example, loss functions 141-142 may be based on mean squared error of, for example as discussed earlier herein, respective label probabilities. Loss function 141 is not based on other partition 102 nor its classes 182-183. Individual loss 151 may be combined, by summation or averaging, to increase or decrease, for training batch 190, both of aggregate losses 161 and 170 but not 162.

Step 206 combines the individual loss of decoding of the current encoding into batch loss 170 that is based on all training inputs 120-122 in training batch 190. Step 206 may entail summation and/or averaging.

For training batch 190, step 207 combines the individual loss of decoding of the current encoding into a partition loss that is based on training inputs only in the partition of the current training input as discussed earlier herein. Step 207 may entail summation and/or averaging. Step 206 may occur before step 207 or vice versa, or steps 206-207 may concurrently occur.

Step 208 occurs once for each training batch and presumes that aggregate losses 161-162 and 170 are already measured for the current training batch. Step 208 may occur before step 209 or vice versa, or steps 208-209 may concurrently occur.

Step 208 backpropagates batch loss 170 into neural encoder 110 without backpropagating batch loss 170 into partition decoder 111. Neural backpropagation is discussed later herein.

For training batch 190, step 209 occurs once for each of partitions 101-102. Into partition decoder 111 for partition 101, step 209 backpropagates partition loss 161 that is based on training inputs only in partition 101, which are only training inputs 120-121. In that way, step 209 independently backpropagates different partition losses 161-162 into respective partition decoders 111-112.

After training such as in a production environment, computer 100 or another computer may generate a local explanation that is a presentation of why neural encoder 110 inferred a particular encoding to semantically represent a particular input, such as a new input that was not in the training corpus. Instead, a global explanation may be generated that is a presentation of what neural encoder 110 generally learned from the training corpus. In either case, the explanation is human interpretable (e.g. textual and/or displayed) and is not based on, as discussed earlier herein, learned or statistically discovered multidimensional clusters. Such clusters would be more or less impractical for a human to interpret. Explanation generation herein is based on partitions 101-102, and an explanation may identify some or all of: partitions 101-102, data fields in an input, and inferred classes or labels. 6.0 EXEMPLARY EMBODIMENT

The following is an exemplary embodiment of computer 100. An application of an encoder model may entail source code representation, where the goal is to produce a semantically relevant vector representation of an arbitrary code snippet (i.e. source logic). One way to inject code structural information into the model is via abstract syntax tree (AST) path prediction. An AST is a tree-based representation of a code snippet's structure that can be represented as a collection of tree traversal paths. Here, the goal is to train the model to predict the AST paths contained in a given code snippet.

Each programming language has its own distinct set of path labels (i.e. classes), and the total count of classes grows linearly with a count of programming languages present in the training corpus. Here, there is one partition and one partition decoder per distinct programming language, such as Java, JavaScript, Python, C/C++, and structured query language (SQL).

For example, neural encoder 110 may accept a training input as a variable length sequence of lexical tokens. Partition decoder 131 infers a decoding that contains a (e.g. unit normalized) frequency of each of classes 180-181 that are some predefined distinct paths that might occur in the AST of the training input. AST generation may entail parsing the training input by a parser. However, neural encoder 110 may be deployed into a production environment that, for example, lacks a parser or sometimes cannot parse an input (i.e. source logic), which neural encoder 110 tolerates. For example in production, neural encoder 110 can still generate an encoding of an input that has a parse error.

When generated by a neural softmax in partition decoder 131, each predicted probability for classes 180-181 ranges from zero to one even though these numbers represent integer counts that may exceed one, and the labels of classes 180-181 for training input 121 also are probabilities that range from zero to one. Thus, loss function 141 should measure loss 151 as a single number that is a difference between the label probabilities of classes 180-181 and the probabilities of classes 180-181 as predicted by partition decoder 131. Loss function 141 may be a Multi-label Cross-Entropy Loss function that measures a difference between two probability distributions in the label space of partition 101.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

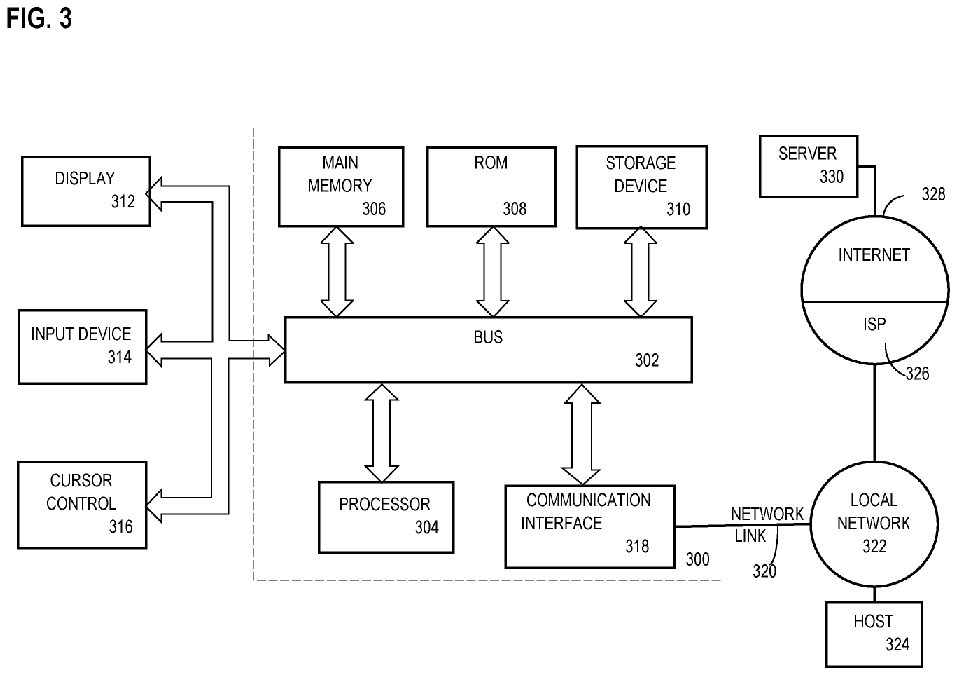

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

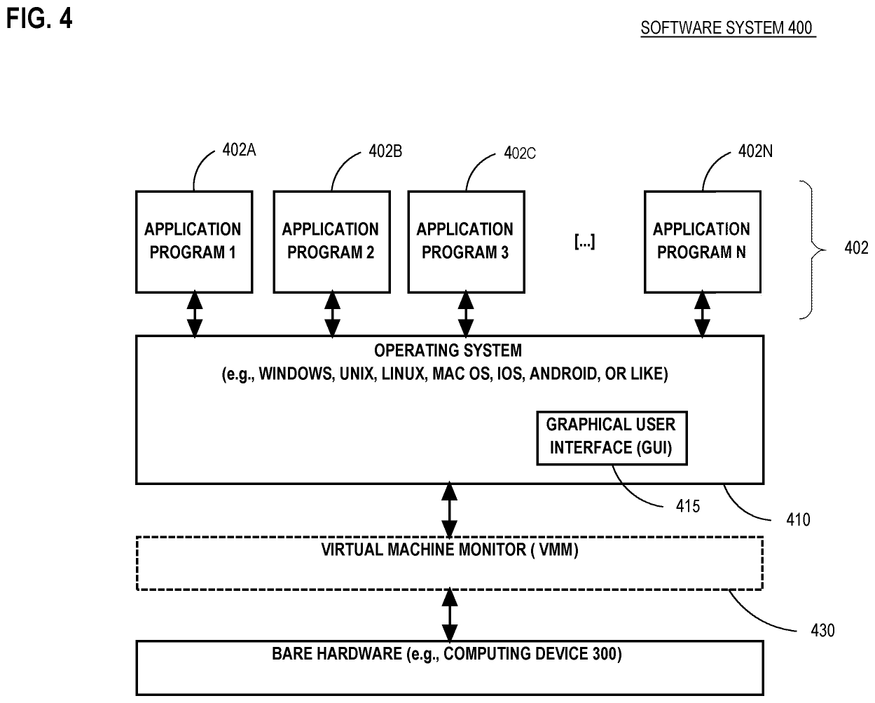

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a plurality of machine learning models that are untrained, wherein:
the plurality of machine learning models contains a neural encoder and a plurality of partition decoders for a plurality of partitions that contains a first partition and a second partition, and
the plurality of partition decoders contains a first partition decoder for the first partition and a second partition decoder for the second partition;
generating a training batch that contains a plurality of training inputs that contains a first training input in the first partition and a second training input in the second partition, wherein each training input of the plurality of training inputs occurs in exactly one partition; and
for each training input in the plurality of training inputs in the training batch, performing:
inferring, by the neural encoder, an encoding of the training input,
selecting, based on the partition of the training input, exactly one partition decoder of the plurality of partition decoders,
measuring a loss of a decoding, by the exactly one partition decoder, of the encoding of the training input,
combining the loss of the decoding of the encoding of the training input into a batch loss that is based on all training inputs in the plurality of training inputs, and
combining the loss of the decoding of the encoding of the training input into a partition loss that is based on the plurality of training inputs only in said partition;
backpropagating the batch loss into the neural encoder without backpropagating the batch loss into the first partition decoder; and
backpropagating, into the first partition decoder, said partition loss that is based on the plurality of training inputs only in the first partition.

2. The method of claim 1 wherein:
each partition decoder of the plurality of partition decoders has a distinct respective loss function;
said measuring the loss of the decoding of the encoding of the training input is based on the loss function of the exactly one partition decoder of the plurality of partition decoders;
said measuring the loss of the decoding of the encoding of the training input is not based on the loss function of a partition decoder of the plurality of partition decoders that is not the exactly one partition decoder.

3. The method of claim 2 wherein:
the loss function of the first partition decoder is based on a classification loss for a plurality of classes in the first partition;
the loss function of the second partition decoder is based on a classification loss for a plurality of classes in the second partition.

4. The method of claim 3 wherein the plurality of classes in the first partition and the plurality of classes in the second partition are disjoint.

5. The method of claim 3 wherein:
said decoding of the encoding of said first training input in the first partition comprises inferring a plurality of probabilities that contains a respective probability for each class in the plurality of classes in the first partition;
a sum of the plurality of probabilities can exceed one.

6. The method of claim 3 wherein each class in the plurality of classes in the first partition indicates a distinct path than can occur in a parse tree.

7. The method of claim 1 wherein:
each training input of the plurality of training inputs in the training batch contains a sequence of non-distinct lexical tokens that has a distinct length;
all encodings of the plurality of training inputs have a uniform size.

8. The method of claim 1 wherein said measuring the loss of the decoding of the encoding of the training input is supervised.

9. The method of claim 1 performed without learned inferring, from content of said training input, said partition of the training input.

10. The method of claim 1 wherein each partition of the plurality of partitions is a distinct programing language.

11. One or more non-transitory computer-readable media storing instructions that, when executed by one or more processors, cause:
generating a plurality of machine learning models that are untrained, wherein:
the plurality of machine learning models contains a neural encoder and a plurality of partition decoders for a plurality of partitions that contains a first partition and a second partition, and
the plurality of partition decoders contains a first partition decoder for the first partition and a second partition decoder for the second partition;
generating a training batch that contains a plurality of training inputs that contains a first training input in the first partition and a second training input in the second partition, wherein each training input of the plurality of training inputs occurs in exactly one partition; and
for each training input in the plurality of training inputs in the training batch, performing:
inferring, by the neural encoder, an encoding of the training input,
selecting, based on the partition of the training input, exactly one partition decoder of the plurality of partition decoders,
measuring a loss of a decoding, by the exactly one partition decoder, of the encoding of the training input,
combining the loss of the decoding of the encoding of the training input into a batch loss that is based on all training inputs in the plurality of training inputs, and
combining the loss of the decoding of the encoding of the training input into a partition loss that is based on the plurality of training inputs only in said partition;
backpropagating the batch loss into the neural encoder without backpropagating the batch loss into the first partition decoder; and
backpropagating, into the first partition decoder, said partition loss that is based on the plurality of training inputs only in the first partition.

12. The one or more non-transitory computer-readable media of claim 11 wherein:
each partition decoder of the plurality of partition decoders has a distinct respective loss function;
said measuring the loss of the decoding of the encoding of the training input is based on the loss function of the exactly one partition decoder of the plurality of partition decoders;
said measuring the loss of the decoding of the encoding of the training input is not based on the loss function of a partition decoder of the plurality of partition decoders that is not the exactly one partition decoder.

13. The one or more non-transitory computer-readable media of claim 12 wherein:
the loss function of the first partition decoder is based on a classification loss for a plurality of classes in the first partition;
the loss function of the second partition decoder is based on a classification loss for a plurality of classes in the second partition.

14. The one or more non-transitory computer-readable media of claim 13 wherein the plurality of classes in the first partition and the plurality of classes in the second partition are disjoint.

15. The one or more non-transitory computer-readable media of claim 13 wherein:
said decoding of the encoding of said first training input in the first partition comprises inferring a plurality of probabilities that contains a respective probability for each class in the plurality of classes in the first partition;
a sum of the plurality of probabilities can exceed one.

16. The one or more non-transitory computer-readable media of claim 13 wherein each class in the plurality of classes in the first partition indicates a distinct path than can occur in a parse tree.

17. The one or more non-transitory computer-readable media of claim 11 wherein:
each training input of the plurality of training inputs in the training batch contains a sequence of non-distinct lexical tokens that has a distinct length;
all encodings of the plurality of training inputs have a uniform size.

18. The one or more non-transitory computer-readable media of claim 11 wherein said measuring the loss of the decoding of the encoding of the training input is supervised.

19. The one or more non-transitory computer-readable media of claim 11 wherein the instructions do not cause learned inferring, from content of said training input, said partition of the training input.

20. The one or more non-transitory computer-readable media of claim 11 wherein each partition of the plurality of partitions is a distinct programing language.
